(19) United States
(12) Patent Application Publication
(10) Pub. No.: US 2013/0108899 A1
(43) Pub. Date: May 2, 2013

(54) LITHIUM-SULPHUR BATTERY

(71) Applicant: Tim Schaefer, Harztor (DE)

(72) Inventor: Tim Schaefer, Harztor (DE)

(73) Assignee: LI-TEC BATTERY GMBH, Kamenz (DE)

(21) Appl. No.: 13/695,024

(22) PCT Filed: Apr. 19, 2011
(86) PCT No.: PCT/EP2011/001983

§ 371 Date: Jan. 7, 2013

(30) Foreign Application Priority Data
Apr. 29, 2010 (DE) 10 2010 018 731.3

(51) Int. Cl. H01M 2/16

(52) U.S. Cl. CPC H01M 2/1666; H01M 2/162; B82Y 30/00
USPC 429/50; 429/144; 977/773

(57) ABSTRACT

The invention relates to a lithium-sulphur battery, comprising (a) a first electrode comprising lithium, (b) a second electrode comprising sulphur and/or a lithium sulphide, (c) a separator between the electrodes (a) and (b), (d) an electrolyte in the separator, characterised in that the separator comprises a non-woven fabric made of polymer fibres.

The present invention relates to a lithium-sulphur battery.

Because of their high energy density and high capacity, secondary batteries (rechargeable batteries) can be used as energy storage devices for mobile information devices. They are also used in tools, electrically operated automobiles and in hybrid drive automobiles. Requirements as regards electrical capacity and energy density for such batteries are high. In particular, they have to remain stable during charging and discharging cycles, i.e. have as little loss of electrical capacity as possible.

While it is already possible to obtain high charge/discharge cycle capacities with lithium ion batteries, this has not been achieved so far with lithium-sulphur batteries. A long service life would, however, be desirable for this type of battery, since they have a substantially higher (theoretical) specific energy density than conventional lithium ion batteries.

The basis of a lithium-sulphur battery is the electrochemical reaction between lithium and sulphur, for example: 16 Li+S₈⇄8Li₂S. Unfortunately, polysulphides, Li₂Sₓ (1≦x≦8) formed at the sulphur electrode during discharge can dissolve in the electrolyte of the battery and also remain dissolved therein. This high solubility results in a loss of active electrode mass. Simultaneously, polysulphide anions can migrate to the lithium metal electrode, where they can form insoluble products. This also has an effect on the performance of the battery. In total, this results in an unsatisfactorily short service life in the charge and discharge cycle. This currently restricts still further the use of lithium-sulphur batteries.

U.S. Pat. No. 6,737,197 B2 discloses lithium-sulphur batteries with solid electrolytes such as ceramic electrolyte separators or glass electrolyte separators, which essentially contain no liquid. The use of polymer electrolytes, for example polyethers such as polyethylene oxides, is also known. Polymer electrolytes can be used in gel form containing organic liquids in a quantity of approximately 20% by weight. The use of separator membranes is also possible. They hold a liquid electrolyte in small pores by means of capillary forces.

German patent application 23 34 660 discloses an electrical accumulator with a negative lithium electrode, a positive sulphur electrode and an organic electrolyte. A fleece formed from glass fibres or electrolyte-resistant plastic, for example polypropylene, is proposed for use as a separator.

An overview of separators which may be used in lithium ion batteries can be found in “Lithium-Ion Batteries, Science and Technology”, M Yoshio, R J Brodd, A Kozawa (editors), 2009, Springer, Chapter 20, pages 367-412. The separators may, for example, be microporous films formed from polypropylene or polyethylene (for example on page 374, final paragraph). Microporous films can also be produced from fibrous materials formed, for example, from polyethylene which has undergone a heat treatment, and used as a separator (p 379, second complete paragraph). Page 381, 2^{nd} paragraph discloses that non-woven materials such as cellulose fibres have not so far been successfully used in lithium ion batteries.

The aim of the present invention is to provide a lithium-sulphur battery which has an improved service life as regards charge-discharge cycles.

The invention provides a lithium-sulphur battery comprising:

(a) a first electrode comprising lithium;

(b) a second electrode comprising sulphur and/or a lithium sulphide;

(c) a separator between the electrodes (a) and (b);

(d) an electrolyte in the separator;

characterized in that the separator comprises a non-woven fabrics formed from polymer fibres.

The term “lithium-sulphur battery” encompasses expressions such as “lithium-sulphur secondary battery”, “lithium sulphide battery”, “lithium-sulphur accumulator”, “lithium-sulphur cell” and the like. This means that the term “lithium-sulphur battery” can be used as a collective expression for the terms that are usually used in the art for this type of battery.

### Electrodes

In one embodiment, the first electrode (a) comprises metallic lithium. When the battery is discharging, (a) is the negative electrode (anode) and the second electric (b) is the positive electric (cathode). The electrochemical reactions can be written as follows:

anode: Li→Li⁺+e⁻; (a)

cathode: S₈+2Li⁺+e⁻Li₂S₈; Li₂S₈→Li₂Sₙ+(8−n)S (b)

Preferably, the positive electrode comprises a carbon matrix in which the sulphur and/or the lithium-sulphide are embedded.

In a further embodiment, the negative electrode comprises a lithium alloy.

Preferred suitable lithium alloys are alloys of lithium with aluminum and tin, for example LiAl or Li₂₂Sn₅.

The lithium alloy is preferably embedded in a matrix formed from carbon. Preferably, in this embodiment, the positive electrode also comprises a matrix formed from carbon.

In one embodiment, the negative electrode comprises an alloy formed from lithium and tin together with carbon. The electrochemical reaction upon discharge can be written as follows:

anode: Li₂₂Sn₅+C→22Li⁺+5Sn/C+22e⁻; (a)

cathode: 11S+C+22 Li⁺+22e⁻→11Li₂S/C. (b)

Electrodes comprising metallic lithium or a lithium alloy are known to have the property whereby they expand during the charging process and contract during the discharging process. This can lead to power loss in the battery. By using a lithium alloy in a matrix formed from carbon, it is possible to compensate for volume changes in the battery.

In a further embodiment, the negative electrode comprises silicon wires with nanoscale dimensions. Using silicon nanowire can also compensate for the unwanted change in volume of the anode upon charging or discharging. Negative electrodes with silicon nanowires are also known as lithium ion accumulators.

In a further embodiment, silicon (in the form of nanowires) replaces the carbon in the anode.

### Separator

Said separator of the battery of the invention comprises polymer fibres in the form of a fleece. By definition, the fibres are not woven. Thus, the fleece is not woven.

Instead of the term “not woven”, the term “non-woven” is also used. The relevant technical literature also uses terms such as “non-woven fabrics” or “non-woven material”. The term “fleece” is synonymous with the term “fleece material”.

The separator used for the battery must be permeable to lithium ions in order to allow ion transport for the lithium ions between the positive and the negative electrode. On the other hand, the separator should be impermeable to sulphide and polysulphide anions. This prevents the circulation of such ions in the battery and their diffusion to the electrode, which comprises metallic lithium or a lithium alloy. Thus, the formation of unwanted low solubility sulphides on this electrode is minimized or even prevented. The separator should also be an insulator to electrons.

Fleeces are known in the art and/or can be produced using known processes, for example by spinning with subsequent solidification. Preferably, the fleece is flexible and is manufactured in a thickness of less than 30 μm.

Preferably, the polymer fibres are selected from the group formed by polymers consisting of polyesters, polyolefins, polyamides, polyacrylonitriles, polyimides, polyetherimides, polysulphones, polyamideimides, polyethers, polyphenylenesulphides and aramids, or mixtures of two or more of these polymers.

Examples of polyesters are polyethylene terephthalate and polybutylene terephthalate.

Examples of polyolefins are polyethylene or polypropylene. Halogen-containing polyolefins such as polytetrafluoroethylene, polyvinylidene fluoride or polyvinyl chloride are also suitable.

Examples of polyamides are the known types PA 6.6 and PA 6.0, known by their trademarks Nylon® and Perlon®.

Examples of aramids are meta-aramid and para-aramid, which are known by their trademarks Nomex® and Kevlar®.

An example of a polyamideimide is that known by its trade mark Kermel®.

In one embodiment, polymer fibres formed from polypropylene are excluded.

In a further embodiment, polymer fibres formed from cellulose are excluded.

Preferred polymer fibres are polymer fibres formed from polyethylene terephthalates.

In a preferred embodiment, the separator comprises a fleece which is coated on one or both sides with an inorganic material.

The term “coating” also encompasses an ion-conducting inorganic material which is not only on one or both sides of the fleece, but also within the fleece.

The inorganic ion-conducting material used for the coating is preferably at least one compound from the group formed by oxides, phosphates, sulphates, titanates, silicates and aluminosilicates of at least one of the elements zirconium, aluminium or lithium.

The ion-conducting inorganic material is preferably ion-conducting in a temperature range from −40° C. to 200° C., i.e. ion-conducting for lithium ions.

In a preferred embodiment, the ion-conducting material comprises or consists of zirconia.

In one embodiment, a separator may be used which consists of an at least partially permeable carrier material which either does not conduct electrons or is a poor conductor of electrons. This carrier is coated on at least one side with an inorganic material. The at least partially permeable carrier used is an organic material which is formed as a fleece, i.e. from non-woven polymer fibres. The organic material is in the form of polymer fibres, preferably polyethylene terephthalate (PET) polymer fibres.

The non-woven fabrics is coated with an inorganic ion-conducting material which is preferably ion-conducting in a temperature range of −40° C. to 200° C. The inorganic ion-conducting material preferably comprises at least one compound from the group formed by oxides, phosphates, sulphates, titanates, silicates and aluminosilicates of at least one of the elements zirconium, aluminium or lithium, particularly preferably zirconia. Preferably, the inorganic ion-conducting material comprises particles with a largest diameter of less than 100 nm.

Such a separator is, for example, supplied by Evonik AG in Germany under the trade name “Separion®”.

Processes for the manufacture of such separators are known in the art, for example from EP 1 017 476 B1, WO 2004/021477 and WO 2004/021499.

In principle, pores and holes in separators which are too big can lead to an internal short circuit when used in secondary batteries. The battery can then self-discharge very rapidly in a dangerous reaction. This can produce electric currents which are so large that in the worst case scenario, a sealed battery cell could even explode. For this reason, the separator can make a decisive contribution to safety or failure of a high power lithium or high energy lithium battery.

Polymer separators generally prevent all charge transport above a specific temperature (the “shut-down temperature”, at approximately 120° C.). This occurs because at this temperature, the pore structure of the separator breaks down and all of the pores are closed up. Since no more ions can be transported, then the dangerous reaction which can lead to an explosion can occur. If, however, external conditions cause the cell to heat up still further, then at approximately 150° C. to 180° C., it exceeds the so-called “breakdown temperature”. Beyond this temperature, the separator melts, and then contracts. Thus, direct contact occurs between the two electrodes at many locations in the battery cell, thus bringing about an extensive internal short circuit. This results in an uncontrolled reaction which could end in explosion of the cell, or the ensuing pressure has to be released through a safety valve (a burst disk), frequently with fire breaking out.

In the separators used in the battery of the invention, comprising a fleece formed from polymer fibres which are not woven and the inorganic coating, only shutdown can occur if the polymer structure of the support material melts due to the high temperature and enters the pores of the inorganic material to close them off thereby. However, the separator does not reach breakdown, since the inorganic particles ensure that complete melting of the separator cannot occur. Thus, it is not possible for an extensive short circuit to occur under any operating conditions.

By means of the type of fleece used, which fleece has a particularly suitable combination of thickness and porosity, separators can be manufactured which can satisfy requirements for separators in high power batteries, in particular high power lithium batteries. The simultaneous use of oxide particles with precisely defined particle sizes for the manufacture of the porous (ceramic) coating means that a particularly high porosity is obtained for the finished separator, wherein the pores are still sufficiently small to prevent “lithium whiskers”from an undesired growing through.

Because of the high porosity of the separator, care must be taken, however, that there is no dead space, or a dead space as small as possible, in the pores.

The separators that can be used in the batteries of the invention also have the advantage that a portion of the anions of the conducting salt can be deposited on the inorganic surfaces of the separator material; this improves dissociation and thus results in a better ion conductivity in the high current region.

The separator for use in the battery of the invention, comprising a flexible fleece with a porous inorganic coating on and in that fleece, wherein the material of the fleece is selected from (non-woven) polymer fabrics, is also characterized in that the fleece has a thickness of less than 30 μm, a porosity of more than 50%, preferably 50% to 97%, and a pore radius distribution wherein at least 50% of the pores have a pore radius of 75 to 150 μm.

Particularly preferably, the separator comprises a fleece with a thickness of 5 to 30 μm, preferably a thickness of 10 to 20 μm. Particularly importantly, the pore radius distribution in the fleece as given above is as homogeneous as possible. An even more homogeneous pore radius distribution in the fleece, along with optimized oxide particles of a specific size, results in optimized porosity of the separator.

The thickness of the substrate has a substantial influence on the properties of the separator, since on the one hand the flexibility but also the sheet resistance of the separator impregnated with electrolyte is dependent on the thickness of the substrate. Being thin means that the electrical resistance of the separator when used with an electrolyte is particularly low. The separator itself has a very high electrical resistance, since it must itself have insulating properties as regards electrons. In addition, thinner separators produce an increased packing density in a multiple-cell battery so that a larger amount of energy can be stored in the same volume.

The non-woven fabrics preferably has a porosity of 60% to 90%, particularly preferably 70% to 90%. The porosity is thus defined as the volume of the fleece (100%) minus the volume of the fibres in the fleece, i.e. the proportion by volume of the fleece which is not filled with material. Thus, the volume of the fleece can be calculated from the dimensions of the fleece. The volume of the fibres is obtained from the measured weight of the fleece in question and the density of the polymer fibres. The high porosity of the substrate also allows for a higher porosity of the separator, hence a high take-up of electrolyte by the separator can be obtained.

So that a separator can be obtained with insulating properties, the polymer fibres in the non-woven fabrics are preferably non-electrically conducting fibres of the polymers defined above. Preferably, they are selected from the polymers cited above, preferably from polyacrylonitrile, a polyester such as polyethylene terephthalate and/or a polyolefin, such as polypropylene or polyethylene, or mixtures of said polyolefins.

The polymer fibres of the fleeces preferably have a diameter of 0.1 to 10 μm, particularly preferably 1 to 4 μm.

Particularly preferred flexible fleeces have a weight per unit area of less than 20 g/m², preferably 5 to 10 g/m².

Preferably, the separator has a porous, electrically insulating ceramic coating on and in the non-woven fabrics. Preferably, the porous inorganic coating on and in the fleece comprises oxide particles of the elements Li, Al, Si and/or Zr with a mean particle size of 0.5 to 7 μm, preferably 1 to 5 μm and particularly preferably 1.5 to 3 μm. Particularly preferably, the separator has a porous inorganic coating on and in the fleece which comprises aluminium oxide particles with a mean particle size of 0.5 to 7 μm, preferably 1 to 5 μm and particularly preferably 1.5 to 3 μm, which is bonded with an oxide of elements Zr or Si. In order to obtain a porosity as high as possible, more than 50% by weight, particularly preferably more than 80% by weight of all particles are within the limits given above for the mean particle size. As described above, the maximum particle size is preferably ⅓ to ⅕ and particularly preferably 1/10 or less of the thickness of the fleece employed.

Preferably, the separator formed from a fleece and a ceramic coating has a porosity of 30% to 80%, preferably 40% to 75% and particularly preferably 45% to 70%. The porosity refers to the accessible pores, i.e. the open pores. The porosity can thus be determined using known mercury porosimetry methods, or it may be calculated from the volume and density of the material employed, assuming that only open pores are present.

The separators used for the battery of the invention are also characterized in that they have a tensile strength of at least 1 N/cm, preferably at least 3 N/cm and particularly preferably 3 to 10 N/cm. The separators can be bent without damage to any radius down to 100 mm, preferably down to 50 mm and particularly preferably down to 1 mm. This means that the separator can also be used in combination with wound electrodes.

The high tensile strength and good bending properties of the separator also have the advantage that changes in the geometry of the electrodes on charging and discharging a battery can be matched by the separator without damaging the latter.

In one embodiment, the separator may be formed such that it is the shape of a concave or convex sponge or cushion or in the form of wires or felt. This embodiment is highly suited to compensating for volume changes of the battery. Appropriate manufacturing processes will be familiar to the skilled person.

In a further embodiment, the polymer fleece used in the separator comprises a further polymer. Preferably, this polymer is disposed between the separator and the electrode (a) and/or the separator and the electrode (b), preferably in the form of a polymer layer.

In one embodiment, the separator is coated with said polymer on one or both sides.

Said polymer may be in the form of a porous membrane, i.e. as a film or in the form of a fleece, preferably in the form of a fleece formed from non-woven polymer fabrics.

Preferably, these polymers are selected from the group consisting of polyester, polyolefin, polyacrylonitrile, polycarbonate, polysulphone, polyethersulphone, polyvinylidene fluoride, polystyrene and polyetherimide.

Preferably, the further polymer is a polyolefin. Preferred polyolefins are polyethylene and polypropylene.

Preferably, the separator is coated with one or more layers of the further polymer, preferably a polyolefin, which is preferably also a fleece, i.e. as non-woven polymer fabrics.

Preferably, a fleece formed from polyethylene terephthalate is used in the separator, which fleece is coated with one or more layers of the further polymer, preferably a polyolefin, which preferably is also a fleece, i.e. non-woven polymer fibres.

Particularly preferably, a separator of the Separion type described above is coated with one or more layers of the further polymer, preferably a polyolefin, which preferably is also a fleece, i.e. non-woven polymer fabrics.

The coating with the further polymer, preferably with the polyolefin, can be produced by bonding, laminating, by means of a chemical reaction, by welding or by a mechanical linkage. Polymer laminates of this type and processes for their manufacture are known from EP 1 852 926.

Preferably, the fleeces which can be used in the separator are prepared from nanofibres of the polymer employed, to produce fleeces which have a high porosity and form small diameter pores. In this manner, the danger of short circuit reactions can be further avoided, as can also the danger of unwanted diffusion of polysulphide anions through the separator.

Preferably, the fibre diameter of the polyethylene terephthalate fleece is larger than the fibre diameter of the further polymer fleece, preferably the polyolefin fleece, with which the separator is coated on one or both sides.

Preferably, the fleece prepared from polyethylene terephthalate then has a higher pore diameter than the fleece produced from the further polymer.

The use of a polyolefin in addition to a polyethylene terephthalate ensures improved safety of the electrochemical cell, since undesirable heating or too much heating of the cell causes the pores of the polyolefin to shrink and reduces or halts charge transport through the separator. If the temperature of the electrochemical is raised so high that the polyolefin starts to melt, the polyethylene terephthalate has the effect of causing the separator to melt down, thereby countering the uncontrolled destruction of the electrochemical cell.

### Electrolyte

The electrolyte that can be inserted into the lithium-sulphur accumulator is a non-aqueous electrolyte. It comprises an organic solvent and a conducting salt.

The organic solvents that may be used are inert under the reaction conditions prevailing in the accumulator. They are preferably selected from ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanone, sulpholane, dimethylsulphoxide, 3-methyl-1,3-oxazolidine-2-one, γ-butyrolactone, 1,2-diethoxymethane, tetrahydrofuran, 2-methyltetrahydrofuran, 1,3-dioxolan, methyl acetate, ethyl acetate, nitromethane, 1,3-propanesultone and mixtures of two or more of these solvents.

The conducting salt is preferably selected from LiPF₆, LiBF₄, LiClO₄, LiAsF₆, LiCF₃SO₃, LiN(CF₃SO₂)₂, LiC(CF₃SO₂)₃, LiSO₃CₓF₂ₓ₊₁, LiN(SO₂CₓF₂ₓ₋₁)₂ or LiC(SO₂CₓF₂ₓ₊₁)₃ with 0≦x≦8, Li[(C₂O₄)₂B] and mixtures of two or more of these salts.

Preferably, polysulphide anions are added to the electrolyte of the lithium-sulphur battery, for example in the form of Li₂S₃, Li₂S₄, Li₂S₆ or Li₂S₈. In one embodiment, the quantity of added polysulphide is such that the electrolyte is saturated with polysulphide. In this manner, the loss of sulphur at the negative electrode can be compensated for. The polysulphide is preferably added before the battery is placed in service.

The electrolyte may comprise further auxiliary substances which are normally used in electrolytes for lithium ion batteries. Examples are radical scavengers such as biphenyl, flame-retarding additives such as organic phosphoric acid esters or hexamethylphosphoramide, or acid scavengers such as amines. Additives such as vinylene carbonate, which can influence the formation of the “solid electrolyte interface” layer (SEI) on the electrodes, preferably carbon-containing electrodes, may also be used.

### Manufacture of Battery

The lithium-sulphur battery may be constructed from components (a) to (d) in accordance with principles which are known in the art and are in routine use for the manufacture of lithium-sulphur batteries.

As an example, to manufacture the positive electrode, sulphur can be ground with carbon, for example in the form of graphite, in a binder. The mass obtained may then be pressed onto aluminium foil. To manufacture the negative electrode, lithium film or a film with a lithium alloy may be pressed onto a suitable support. The separator is impregnated with electrolyte and the electrodes are laminated onto the saturated separator. A ready-charged battery is obtained.

In a further embodiment, it is also possible to manufacture the battery in the discharged state. To this end, a positive electrode is manufactured which contains a composite of a lithium sulphide and carbon. The negative electrode comprises the support for the lithium metal, but is free of lithium metal or lithium alloy. The separator is impregnated with the electrolyte and the electrodes are laminated onto the impregnated separator. Upon charging the battery, electrons go into the sulphur electrode and the electrode is reduced with lithium metal or lithium alloy.

### Use

The lithium-sulphur battery of the invention may be used to provide energy for mobile information devices, tools, electrically operated automobiles and automobiles with hybrid drives.

1-15. (canceled)

16. A lithium-sulphur battery comprising:
(a) a first electrode comprising lithium;
(b) a second electrode comprising sulphur and/or a lithium sulphide;
(c) a separator between the electrodes (a) and (b); and
(d) an electrolyte in the separator,
wherein the separator comprises a non-woven fabrics formed from polymer fibers, wherein a porous inorganic coating which can conduct lithium ions is provided in the non-woven fabrics and/or on one or both sides of the non-woven fabrics.

17. The lithium-sulphur battery as claimed in claim 16, wherein lithium metal or a lithium alloy is present in the first electrode

18. The lithium-sulphur battery of claim 16, wherein one or both of the first and second electrodes comprise(s) carbon.

19. The lithium-sulphur of claim 16, wherein the polymer fibers are selected from the group formed by polymers selected from the group consisting of polyester, polyolefin, polyamide, polyacrylonitrile, polyimide, polyetherimide, polysulphone, polyamideimide, polyether, polyphenylenesulphide and aramid, or mixtures of two or more of these polymers.

20. The lithium-sulphur battery of claim 16, wherein the polymer fibers comprise a polyethylene terephthalate.

21. The lithium-sulphur battery of claim 16, wherein the separator comprises an at least partially permeable carrier which is not or is only poorly electron-conductive, wherein the carrier is coated with an inorganic material on at least one side, wherein an organic material is used as the at least partially permeable carrier, which is formed as a non-woven fabric, wherein the organic material is in the form of polymer fibers, preferably polymer fibers formed from polyethylene terephthalate (PET), wherein the non-woven fabric is coated with an inorganic ion-conducting material.

22. The lithium-sulphur battery of claim 21, wherein the inorganic ion-conducting material is ion-conducting in a temperature range of −40° C. to 200° C.

23. The lithium-sulphur battery of claim 21, wherein the inorganic ion-conducting material comprises at least one compound from the group consisting of oxides, phosphates, sulphates, titanates, silicates and aluminosilicates of at least one of the elements zirconium, aluminium and lithium.

24. The lithium-sulphur battery of claim 21, wherein the inorganic ion-conducting material comprises zirconia.

25. The lithium-sulphur battery of claim 21, wherein the inorganic ion-conducting material comprises particles with a maximum diameter of less than 100 nm

26. The lithium-sulphur battery of claim 16, wherein the separator is in the form of a concave or convex sponge or cushion or in the form of wires or a felt.

27. The lithium-sulphur battery of claim 16, wherein between the separator and the first electrode and/or between the separator and the second electrode is a polymer layer which is formed as a foil or as a fleece.

28. The lithium-sulphur battery as claimed in claim 27, wherein the polymer layer comprises a polyolefin.

29. The lithium-sulphur battery of claim 16, wherein the electrolyte comprises an organic solvent and a conducting salt.

30. The lithium-sulphur battery as claimed in claim 29, wherein the organic solvent is selected from ethylene carbonate, propylene carbonate, butylene carbonate, dimethyl carbonate, diethyl carbonate, ethylmethyl carbonate, methylpropyl carbonate, butylmethyl carbonate, ethylpropyl carbonate, dipropyl carbonate, cyclopentanone, sulpholane, dimethylsulphoxide, 3-methyl-1,3-oxazolidine-2-one, γ-butyrolactone, 1,2-diethoxymethane, tetrahydrofuran, 2-methyltetrahydrofuran, 1,3-dioxolan, methyl acetate, ethyl acetate, nitromethane, 1,3-propanesultone and mixtures of two or more of these solvents.

31. The lithium-sulphur battery as claimed in claim 29, wherein the conducting salt is selected from LiPF6, LiBF4, LiClO4, LiAsF6, LiCF3SO3, LiN(CF3SO2)2, LiC(CF3SO2)3, LiSO3CxF2x+1, LiN(SO2CxF2x+1)2 or LiC(SO2CxF2x+1)3 with 0 x 8, Li[(C204)2B] and mixtures of two or more of these salts.

32. The lithium-sulphur battery of claim 16, wherein the electrolyte comprises a polysulphide which is added to the electrolyte before putting the battery into service.

33. A method, comprising:
using a lithium-sulphur battery as recited in claim 16 to supply energy for mobile information devices, tools, electrically operated automobiles and for hybrid drive automobiles.
